(19) United States
(12) Patent Application Publication
(10) Pub. No.: US 2026/0054745 A1
(43) Pub. Date: Feb. 26, 2026

(54) METHOD AND APPARATUS FOR EVALUATING ACCURACY OF PATH PREDICTION

(71) Applicants: Hyundai Motor Company, Seoul (KR); Kia Corporation, Seoul (KR)

(72) Inventor: Sung Wook Lee, Hwaseong-si (KR)

(21) Appl. No.: 19/229,210

(22) Filed: Jun. 5, 2025

(30) Foreign Application Priority Data
Aug. 22, 2024 (KR) 10-2024-0112625

(51) Int. Cl. B60W 60/00; B60W 30/02; B60W 50/00

(52) U.S. Cl. CPC B60W 60/001; B60W 30/02; B60W 50/0097; B60W 2520/105; B60W 2520/125; B60W 2520/14; B60W 2556/20

(57) ABSTRACT

In an embodiment, evaluating path prediction accuracy. An embodiment of the present disclosure provides determining accuracy of a predicted path for a vehicle, including receiving first predicted path generated at a current time point and second predicted path generated before the current time point; determining path prediction error of a n-th point in the first predicted path based on a difference between driving information of the vehicle at the current time point and driving information of a n-th point related to the current time point in the second predicted path, wherein the n is an integer greater than 0 and less than or equal to the number of points in the predicted path; and determining path prediction accuracy of n-th segment based on the path prediction error of the n-th point in the first predicted path, wherein the n-th segment is the first predicted path up to the n-th point.

### CROSS-REFERENCE TO RELATED APPLICATIONS

This application claims priority to Korean Patent Application No. 10-2024-0112625, filed on Aug. 22, 2024 in the Korea Intellectual Property Office, the entire contents of which are incorporated herein by reference.

### TECHNICAL FIELD

The present disclosure relates to a method and an apparatus for evaluating accuracy of path prediction. More specifically, the present disclosure relates to a method and an apparatus for evaluating accuracy of path prediction, which enables real-time calculation of accuracy for each segment of predicted path of a subject vehicle using the error from the path predicted at past points in time and driving information of the subject vehicle.

### BACKGROUND

The matters described in this Background section are only for enhancement of understanding of the background of the disclosure, and should not be taken as acknowledgement that they correspond to prior art already known to those skilled in the art.

An autonomous driving system predicts the subject vehicle's path for path planning, collision avoidance decision, and other related tasks. For example, an autonomous vehicle calculates the likelihood of collision with surrounding objects using the predicted path and performs driver warnings and evasive maneuvers.

Autonomous vehicles perform collision avoidance decision only on the paths deemed valid to avoid unnecessary calculations. In the past, the validity of path prediction was determined based on whether the signal from a sensor attached to the autonomous vehicle was valid. In other words, if the sensor signal was valid, the predicted path calculated using the sensor signal was also considered valid. However, conventional methods have limitations in evaluating the accuracy of path prediction, since they do not consider other factors that influence path prediction.

Moreover, conventional methods only evaluate the accuracy of path prediction for the entire predicted path and do not provide the prediction accuracy for each segment. This limitation results in reduced control performance of the autonomous vehicle, leading to unnecessary warnings and vehicle controls.

For example, an autonomous driving system predicts the path of the subject vehicle and the path of a target, and performs a collision avoidance decision using the predicted paths. If the predicted paths are deemed valid, conventional autonomous driving systems perform collision avoidance decision for the entire path. Since collision avoidance decision is performed on segments where the path prediction accuracy is not sufficiently high, resources of the autonomous driving system are used inefficiently. In addition, if Time-To-Collision (TTC) is calculated and collision risk is determined for the segments with low path prediction accuracy, false warnings and incorrect vehicle control may occur. Therefore, it is necessary to perform collision avoidance decision only on the segments with high path prediction accuracy.

### SUMMARY

Embodiments provide a method and an apparatus, which enables real-time calculation of accuracy of paths predicted by an autonomous driving system.

Embodiments provide a method and an apparatus, which enables evaluation of accuracy of paths predicted by an autonomous driving system for each segment.

Embodiments provide accuracy of predicted path based on the segment length of a predicted path and/or the uncertainties due to the driving situation of an autonomous vehicle.

Technical achievements by the present disclosure are not limited to those described above, and other achievements not mentioned above may also be clearly understood from the detailed descriptions given below by those skilled in the art to which the present disclosure belongs.

An embodiment of the present disclosure provides a method for determining accuracy of a predicted path for a vehicle, wherein the predicted path is a sequence of points representing driving information of the vehicle at each of plurality of time points in the prediction time window, the method comprising: receiving first predicted path generated at a current time point and second predicted path generated before the current time point; determining path prediction error of a n-th point in the first predicted path based on a difference between driving information of the vehicle at the current time point and driving information of a n-th point related to the current time point in the second predicted path, wherein the n is an integer greater than 0 and less than or equal to the number of points in the predicted path; and determining path prediction accuracy of n-th segment based on the path prediction error of the n-th point in the first predicted path, wherein the n-th segment is the first predicted path up to the n-th point.

Another embodiment of the present disclosure provides an apparatus for determining accuracy of a predicted path for a vehicle, wherein the predicted path is a sequence of points representing driving information of the vehicle at each of plurality of time points in the prediction time window, the apparatus comprising: at least one memory storing commands; and at least one processor, wherein the at least one processor executes the commands to: receive first predicted path generated at a current time point and second predicted path generated before the current time point; determine path prediction error of a n-th point in the first predicted path based on a difference between driving information of the vehicle at the current time point and driving information of a n-th point related to the current time point in the second predicted path, wherein the n is an integer greater than 0 and less than or equal to the number of points in the predicted path; and determine path prediction accuracy for n-th segment based on the path prediction error of the n-th point in the first predicted path, wherein the n-th segment is the first predicted path up to the n-th point.

According to one embodiment of the present disclosure, the accuracy of each segment of a path predicted by an autonomous driving system may be evaluated in real-time.

According to one embodiment of the present disclosure, the performance of evaluating the accuracy of path prediction may be improved by comparing the driving information predicted at past points in time with the current driving information.

According to one embodiment of the present disclosure, the performance of evaluating the accuracy of path prediction may be improved by considering the length of segments of a predicted path.

According to one embodiment of the present disclosure, the performance of evaluating the accuracy of path prediction may be improved by considering uncertainties due to driving situations.

According to one embodiment of the present disclosure, the collision avoidance performance of an autonomous vehicle may be improved by evaluating the risk of collision only for valid path segments using path prediction accuracy by segment.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 shows a block diagram of a path evaluation apparatus according to one embodiment of the present disclosure.

FIGS. 2a to 2d show a method for calculating a path prediction error for each segment by a path evaluation apparatus according to one embodiment of the present disclosure.

FIG. 3 shows a method for calculating the path prediction accuracy by segment using the path prediction error for each segment by a path evaluation apparatus according to one embodiment of the present disclosure.

FIG. 4 shows a method for determining collision using path prediction accuracy for each segment.

FIG. 5a is a flow diagram illustrating calculating the path prediction accuracy for each segment by a path evaluation apparatus according to one embodiment of the present disclosure.

FIG. 5b is a flow diagram illustrating calculating the path prediction accuracy for each segment by a path evaluation apparatus according to another embodiment of the present disclosure.

FIG. 6 is a block diagram schematically illustrating an example computing device that can be used to implement the method or device according to embodiments of the present disclosure.

### DETAILED DESCRIPTION OF ILLUSTRATIVE EMBODIMENTS

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

In the present disclosure, path prediction refers to the function of an autonomous driving system to predict a path that an autonomous vehicle will follow or predicted outcome.

In the present disclosure, a prediction time window refers to the length of a path predicted by the autonomous driving system. The prediction time window may be expressed in units of time. For example, if the autonomous driving system predicts a path that the autonomous vehicle will follow for the next 4 seconds, the length of the prediction time window is 4 seconds.

In the present disclosure, a time interval refers to the interval between adjacent time points in the prediction time window. The time interval may be expressed in units of time.

In the present disclosure, a predicted path of vehicle is represented by a sequence of points, each of which represents the vehicle's driving information (position, velocity, heading angle, etc.) at the corresponding time point. The size of the sequence (number of elements) is determined based on the length of the prediction time window and the time interval. For example, if the prediction time window is 4 seconds and the prediction interval is 0.1 seconds, the sequence of points has 41 elements (=4 s/0.1 s+1).

In the present disclosure, path prediction accuracy refers to the degree to which a predicted path can be reliable. High path prediction accuracy indicates that the subject vehicle is highly likely to drive along the predicted path, while low path prediction accuracy indicates that the subject vehicle is less likely to drive along the predicted path.

In the present disclosure, path prediction accuracy by segment refers to the path prediction accuracy for each segment forming the predicted path. Moreover, n-th segment is the predicted path up to the n-th point in the predicted path For example, if the prediction time window is 4 seconds and the prediction interval is 1 second, the path prediction accuracy by segment refers to the path prediction accuracy of the first segment which is the path from the current time point to 1 second later, the path prediction accuracy of the second segment which is the path from the current time point to 2 seconds later, the path prediction accuracy of the third segment which is the path from the current time point to 3 seconds later, and the path prediction accuracy of the fourth segment which is the path from the current time point to 4 seconds later.

The path evaluation apparatus according to the present disclosure may output the path prediction accuracy by segment. The path evaluation apparatus or the autonomous driving system according to the present disclosure may determine the valid segments of a predicted path based on the path prediction accuracy by segment. In the example above, if the path prediction accuracy of the second segment is high but the path prediction accuracy of the third segment is low, the path evaluation apparatus or the autonomous driving system may determine that the path is valid from the current time point to 2 seconds later.

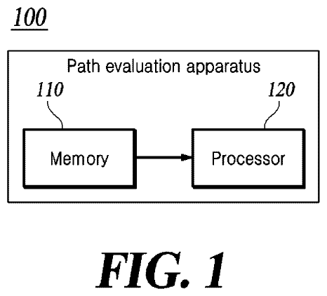

FIG. 1 shows a block diagram of a path evaluation apparatus according to one embodiment of the present disclosure.

The path evaluation apparatus 100 includes a memory 110 and a processor 120. The path evaluation apparatus 100 may be implemented in the form of an embedded device, a server, an electronic device within an autonomous driving system, and the like. Not all blocks shown in FIG. 1 are essential components, and a portion of blocks included in the path evaluation apparatus 100 may be added, modified, or deleted in other embodiments. Meanwhile, the constituting elements shown in FIG. 1 represent functionally distinct elements, and at least one constituting element may be implemented in a form in which it is integrated with another element in the actual physical environment.

The memory 110 may store driving information of a subject vehicle. The driving information may include velocity, acceleration, steering angle, steering angular velocity, heading angle, and/or yaw rate of the subject vehicle.

The memory 110 may store current driving information of the subject vehicle. The current driving information of the subject vehicle includes the current position (x, y) and/or the current heading angle θ of the subject vehicle. The path evaluation apparatus 100 may calculate the current driving information of the subject vehicle using previous driving information of the subject vehicle stored in the memory 110.

For example, the path evaluation apparatus 100 may calculate the current driving information by applying dead reckoning. Since a specific method of calculating the current driving information from the driving information at a previous time point using dead reckoning is well known, so we will not describe it in detail. The current driving information of the subject vehicle may also be directly obtained using a position estimation device, such as GPS.

The memory 110 may store path prediction data generated at past points in time. For example, the memory 110 may store the path predicted 1 second ago, the path predicted 2 seconds ago, the path predicted 3 seconds ago, and the path predicted 4 seconds ago.

The path prediction data includes the positions, heading angles, and/or velocities of the subject vehicle at each time point. The path evaluation apparatus 100 may obtain the position, heading angle, and/or velocity of the subject vehicle t seconds later predicted t seconds ago, using the path prediction data generated at past point in time. For example, the path evaluation apparatus 100 may obtain the position, heading angle, and/or velocity of the subject vehicle 1 second later predicted 1 second ago.

The memory 110 may store data and commands required for the operation of the path evaluation apparatus 100. The memory 110 may be implemented with at least one of a volatile storage medium or a non-volatile storage medium, or a combination thereof. The memory 110 may be implemented with various types of storage media. The memory 110 may include at least one type of storage medium among a flash memory type, a hard disk type, a multimedia card micro type, a card type memory (e.g., an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. According to one embodiment, the memory 110 may correspond to a cloud storage space. For example, the path evaluation apparatus 100 and the memory 110 may be implemented through a cloud service.

The processor 120 controls the overall operation of the path evaluation apparatus 100. The processor 120 may be implemented as one or more processors.

The processor 120 calculates the path prediction accuracy by segment using the data stored in the memory 110. In one embodiment of the present disclosure, the processor 120 may calculate the path prediction accuracy by segment based on the path prediction error. In another embodiment of the present disclosure, the processor 120 may calculate the path prediction accuracy by segment based on the path prediction error and the driving status information of the subject vehicle.

In the present disclosure, the path prediction error refers to driving information error of the n-th point in the predicted path, wherein the n is an integer greater than 0 and less than or equal to the number of points in the predicted path. The driving information error of the n-th point in the predicted path is considered to be a difference between driving information of the subject vehicle at the current time and driving information of the n-th point related to the current time in a predicted path generated before a current time. The path prediction error may comprise a position error and/or a velocity error.

Eq. 1 represents a formula for calculating the position error.

$${PE}_{i} = {{w}_{1} ( {X}_{0} - {X}_{i} )}^{2} + {{w}_{2} ( {Y}_{0} - {Y}_{i} )}^{2} + {{w}_{3} ( {θ}_{0} - {θ}_{i} )}^{2} \qquad [ Eq . 1 ]$$

In Eq. 1, PEᵢ represents the position error which is a difference between position of the subject vehicle at the current time (t=0) and position of the i-th point related to the current time in a predicted path generated at past time (t=−tᵢ). (X₀, Y₀) represents the coordinates of the current position of the subject vehicle, and θ₀ represents the current heading angle of the subject vehicle. (Xᵢ, Yᵢ) represents the coordinates of current position of the subject vehicle predicted at a past time point (t=−tᵢ), and θᵢ represents current heading angle of the subject vehicle predicted at a past time point (t=−tᵢ). w₁, w₂, and w₃ represent the weights of each term, where the sum of the weights is 1 (w₁+w₂+w₃=1).

Eq. 2 represents a formula for calculating the velocity error.

$${VE}_{i} = {( {V}_{0} - {V}_{i} )}^{2} \qquad [ Eq . 2 ]$$

In Eq. 2, VEᵢ represents the velocity error which is a difference between velocity of the subject vehicle at the current time (t=0) and velocity of the i-th point related to the current time in a predicted path generated at past time (t=−tᵢ). V₀ represents the current velocity of the subject vehicle. Vᵢ represents the current velocity of the subject vehicle predicted at a past time point (t=−tᵢ).

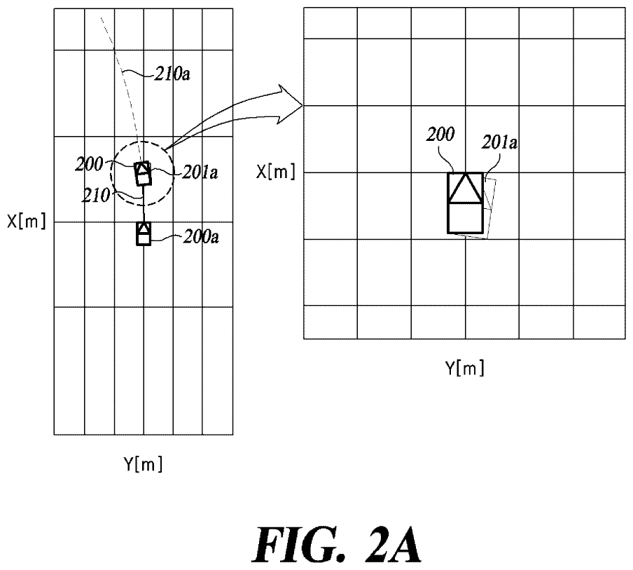

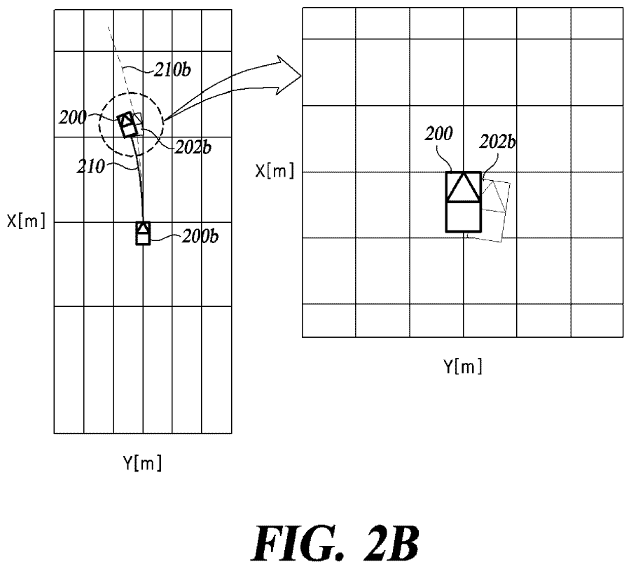

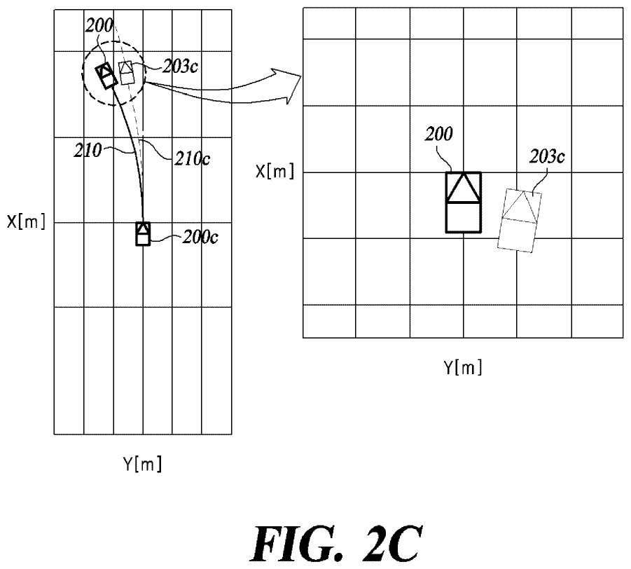

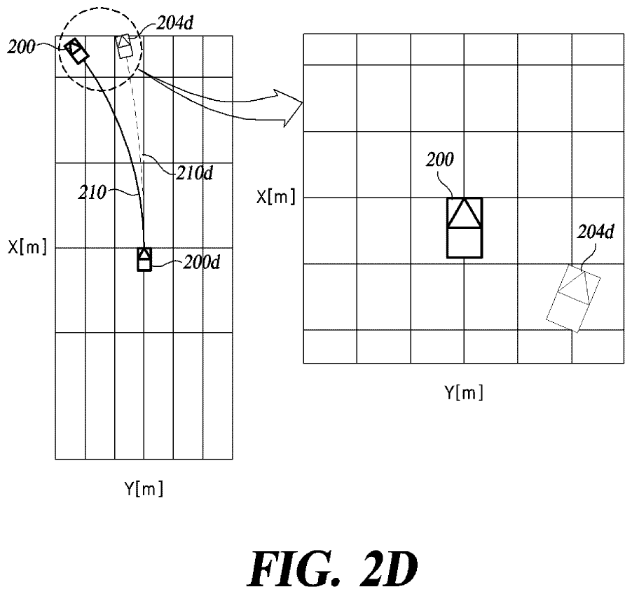

FIGS. 2a to 2d show a method for calculating a path prediction error for each segment by the path evaluation apparatus 100 according to one embodiment of the present disclosure using Eqs. 1 and 2.

In the embodiments of the present disclosure, it is assumed that the prediction time window is 4 seconds and the path prediction error is calculated at 1-second intervals. Accordingly, the path evaluation apparatus 100 may calculates the path prediction error using the current driving information of the vehicle predicted 1 second ago, the current driving information of the vehicle predicted 2 seconds ago, the current driving information of the vehicle predicted 3 seconds ago, and the current driving information of the vehicle predicted 4 seconds ago. In what follows, i-th path prediction error refers to error of driving information predicted i seconds ago, i.e. driving information error of the i-th point in the predicted path.

FIG. 2a shows the process of calculating the first path prediction error. In FIG. 2a, the dotted line 210a represents the path predicted at the vehicle position 200a, and the solid line 210 represents the actual driving path that the vehicle has traveled over the past 1 second. The current position of the vehicle 200 is (X₀, Y₀, θ₀), the position 200a which is the position of vehicle 1 second ago is

$$( {X}_{0}^{′} , {Y}_{0}^{′} , {θ}_{0}^{′} ) ,$$

and the position 201a which is the position of vehicle predicted 1 second ago is (X₁, Y₁, θ₁).

The figure on the right of FIG. 2a represents the current position 200 and the predicted position 201a, mapped to the coordinate system of the current time point. The path evaluation apparatus 100 may map the position of the vehicle from the coordinate system of the previous time point to the coordinate system of the current time point using the difference (ΔX₀, ΔY₀, Δθ₀) between the position of the vehicle 200a and the current position of the vehicle 200. In other words, the path evaluation apparatus 100 may map the driving information predicted in the past to the coordinate system of the current time point by performing translation and/or rotation on the predicted information. The path evaluation apparatus 100 compares the driving information of the vehicle predicted in the past with the current driving information of the vehicle in the coordinate system of the current time point. In other words, the path evaluation apparatus 100 compares the path predicted in the past with the actual driving path to determine the path prediction accuracy in real-time.

Since the position of the vehicle 201a predicted at the position 200a is (X₁, Y₁, θ₁), and the current position of the vehicle 200 is (X₀, Y₀, θ₀), the first position error PE₁ may be calculated by substituting (X₁, Y₁, θ₁) and (X₀, Y₀, θ₀₎ into Eq. 1.

If the velocity of the vehicle predicted at the position of the vehicle 200a is V₁, and the current velocity of the vehicle is V₀, the first velocity error VE₁ may be calculated by substituting V₁ and V₀ into Eq. 2.

FIG. 2b shows the process of calculating the second path prediction error. In FIG. 2b, the dotted line 210b represents the path predicted at the vehicle position 200b, and the solid line 210 represents the actual driving path that the vehicle has traveled over the past 2 seconds. The figure on the right of FIG. 2b represents the current position of the vehicle 200 and the position of the vehicle 202b predicted 2 seconds ago, mapped to the coordinate system of the current time point.

If the position of the vehicle 202b predicted at the position of the vehicle 200b is (X₂, Y₂, θ₂), and the current position of the vehicle 200 is (X₀, Y₀, θ₀), the second position error PE₂ may be calculated by substituting (X₂, Y₂, θ₂) and (X₀, Y₀, θ₀₎ into Eq. 1.

If the velocity of the vehicle predicted at the position of the vehicle 200b is V₂, and the current velocity of the vehicle is V₀, the second velocity error VE₂ may be calculated by substituting V₂ and V₀ into Eq. 2.

FIG. 2c shows the process of calculating the third path prediction error. In FIG. 2c, the dotted line 210c represents the path predicted at the position of the vehicle 200c, and the solid line 210 represents the actual driving path that the vehicle has traveled over the past 3 seconds. The figure on the right of FIG. 2c represents the current position 200 and the predicted position 203c, mapped to the coordinate system of the current time point.

If the position of the vehicle 203c predicted at the position of the vehicle 200c is (X₃, Y₃, θ₃), and the current position of the vehicle 200 is (X₀, Y₀, θ₀), the third position error PE₃ may be calculated by substituting (X₃, Y₃, θ₃) and (X₀, Y₀, θ₀₎ into Eq. 1.

If the velocity of the vehicle predicted at the position of the vehicle 200c is V₃, and the current velocity of the vehicle is V₀, the third velocity error VE₃ may be calculated by substituting V₃ and V₀ into Eq. 2.

FIG. 2d shows the process of calculating the fourth path prediction error. In FIG. 2d, the dotted line 210d represents the path predicted at the vehicle position 200d, and the solid line 210 represents the actual driving path that the vehicle has traveled over the past 4 seconds. The figure on the right of FIG. 2d represents the current position of the vehicle 200 and the position of the vehicle 204d predicted 4 seconds ago, mapped to the coordinate system of the current time point.

If the position of the vehicle 204d predicted at the position of the vehicle 200d is (X₄, Y₄, θ₄), and the current position of the vehicle 200 is (X₀, Y₀, θ₀), the fourth position error PE₄ may be calculated by substituting (X₄, Y₄, θ₄) and (X₀, Y₀, θ₀₎ into Eq. 1.

If the velocity of the vehicle predicted at the position of the vehicle 200d is V₄, and the current velocity of the vehicle is V₀, the fourth velocity error VE₄ may be calculated by substituting V₄ and V₀ into Eq. 2.

The calculation of the path prediction error by segment (the first to fourth path prediction errors) described with reference to FIGS. 2a to 2d is performed in real-time. In other words, the path prediction error by segment may be calculated simultaneously or sequentially at the current time.

The path evaluation apparatus 100 according to one embodiment of the present disclosure calculates the path prediction accuracy by segment in real-time using the path prediction error.

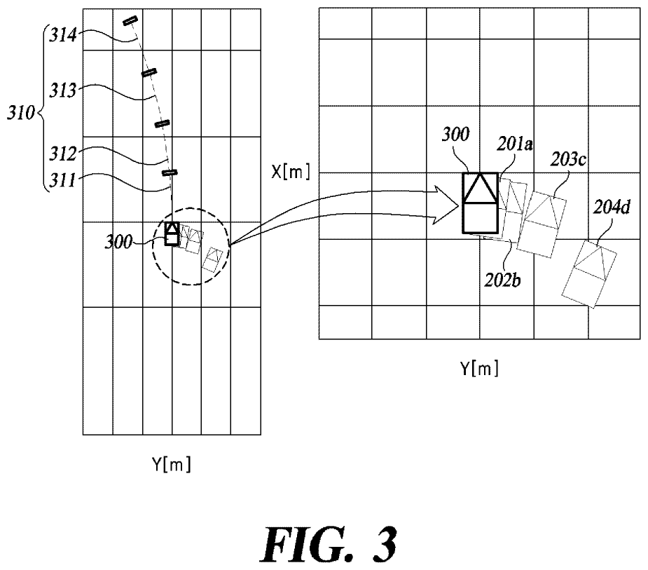

FIG. 3 shows a method for calculating the path prediction accuracy by segment using the path prediction error for each segment by the path evaluation apparatus 100 according to one embodiment of the present disclosure. In FIG. 3, the dotted line 310 indicates a 4-second-long path predicted at the current time point. The path evaluation apparatus 100 calculates in real-time the path prediction accuracy of the first segment 311, the path prediction accuracy of the second segment 312, the path prediction accuracy of the third segment 313, and the path prediction accuracy of the fourth time section 314. In FIG. 3, the path prediction accuracy by segment refers to the path prediction accuracy of the first to fourth segments.

The figure on the right of FIG. 3 shows the current vehicle position 300 and the vehicle positions 201a to 204d predicted in the past mapped to the coordinate system of the current time point. The path evaluation apparatus 100 performs translation and/or rotation transformation to map the driving information predicted in the past to the coordinate system of the current time point. The path evaluation apparatus 100 compares the current driving information 300 of the vehicle with the driving information of the vehicle 201a to 204d predicted in the past in the coordinate system of the current time point.

Eq. 3 represents a formula for calculating the path prediction accuracy by segment using the path prediction error for each segment according to one embodiment of the present disclosure.

$${A}_{i} = \frac{C}{{PE}_{i} \cdot {VE}_{i}} \qquad [ Eq . 3 ]$$

In Eq. 3, Aᵢ represents the path prediction accuracy of the i-th segment. PEᵢ represents the position error calculated using Eq. 1. VEᵢ represents the velocity error calculated using Eq. 2. C represents a normalization constant. The normalization constant C is used to normalize the path prediction accuracy to a value within a predetermined range and is determined based on test data.

According to Eq. 3, a larger path prediction error results in lower path prediction accuracy, whereas a smaller path prediction error leads to higher path prediction accuracy. It should be noted that Eq. 3 is only an example, and any formula that makes the path prediction accuracy proportional to the inverse of the path prediction error may be used to calculate the path prediction accuracy.

The path evaluation apparatus 100 according to one embodiment of the present disclosure calculates the path prediction accuracy A₁ of the first segment by inserting the first path prediction error (PE₁ and VE₁) into Eq. 3. The path evaluation apparatus 100 calculates the path prediction accuracy A₂ of the second segment by inserting the second path prediction error (PE₂ and VE₂) into Eq. 3. The path evaluation apparatus 100 calculates the path prediction accuracy A₃ of the third segment by inserting the third path prediction error (PE₃ and VE₃) into Eq. 3. The path evaluation apparatus 100 calculates the path prediction accuracy A₄ of the fourth segment by inserting the fourth path prediction errors (PE₄ and VE₄) into Eq. 3.

Eq. 4 represents a formula for calculating the path prediction accuracy by segment according to another embodiment of the present disclosure.

$${A}_{i} = \frac{C}{{PE}_{i} * {VE}_{i}} * {CF}_{i} \qquad [ Eq . 4 ]$$

In Eq. 4, Aᵢ, C, PEᵢ, and VEᵢ are defined in the same manner as in Eq. 3. CFᵢ represents a correction factor. The correction factor CF; is used to correct the i-th path prediction accuracy determined using Eq. 3. The value of the correction factor CF has a larger value as the path prediction uncertainty increases and has a smaller value as the path prediction uncertainty decreases. The path prediction uncertainty may be determined using at least one of the length of a segment and the driving stability of the subject vehicle. In another embodiment of the present disclosure, the correction factor CF may be determined using a correction factor table.

If the correction factor CF is determined based on the length of the segment, the correction factor CF is assigned a smaller value as the length of the segment increases and a larger value as the length of the segment decreases. For example, the correction factor CF for the first time section 311 is assigned a smaller value than the correction factor CF for the fourth segment 314.

As the prediction time point gets closer to the current time point, the path prediction is likely to be more accurate; conversely, as the prediction time moves further from the current time point, the path prediction is likely to become less accurate. By setting the correction factor CF to be proportional to the inverse of the length of the segment, the path prediction uncertainty due to the length of the segment may be taken into account.

When the correction factor CF is determined based on the driving stability of an subject vehicle, the correction factor CF is assigned a larger value as the driving stability of the subject vehicle increases and a smaller value as the driving stability of the subject vehicle decreases.

The driving stability of an subject vehicle may be determined using driving data of the subject vehicle periodically measured from a previous time point to the current time point. For example, if the predicted time window is 4 seconds, the driving stability may be determined using driving data from 4 seconds ago to the current time point. The driving data of the subject vehicle includes at least one of the velocity, acceleration, steering angle, steering angular velocity, heading angle, and yaw rate of the subject vehicle. If longitudinal acceleration, lateral acceleration, yaw rate, and steering angular velocity of the subject vehicle are used, the processor 120 stores driving data for the predicted time window. The processor 120 calculates the variance for each data and sums the calculated variances.

If the sum of variances is small, the driving stability of the subject vehicle is likely to be high; if the sum of variances is large, the driving stability of the subject vehicle is likely to be low. By setting the correction factor CF to be proportional to the inverse of the sum of variances, the path prediction uncertainty resulting from driving environments and situations may be taken into account.

The path evaluation apparatus 100 according to another embodiment of the present disclosure calculates the path prediction accuracy A₁ of the first segment by inserting the first path prediction error (PE₁ and VE₁) and correction factor CF₁ into Eq. 4. The path evaluation apparatus 100 calculates the path prediction accuracy A₂ of the second segment by inserting the second path prediction error (PE₂ and VE₂) and correction factor CF₂ into Eq. 4. The path evaluation apparatus 100 calculates the path prediction accuracy A₃ of the third segment by inserting the third path prediction error (PE₃ and VE₃) and correction factor CF₃ into Eq. 4. The path evaluation apparatus 100 calculates the path prediction accuracy A₄ of the fourth segment by inserting the fourth path prediction error (PE₄ and VE₄) and correction factor CF₄ into Eq. 4.

The autonomous driving system may determine the validity of a path for each segment using the path prediction accuracy by segment. If the path prediction accuracy is higher than a predetermined reference value, the autonomous driving system determines the predicted path as a valid path. If the path prediction accuracy is lower than the predetermined reference value, the autonomous driving system may determine the predicted path as an invalid path. For example, in FIG. 3, the autonomous driving system may determine the path of the first segment 311 as a valid path if the path prediction accuracy of the first segment is 0.7 or higher and may determine the path of the first segment 311 as an invalid path if the path prediction accuracy of the first segment is less than 0.7.

The validity information of the path prediction may be used for the driving control of the autonomous driving system. For example, the autonomous driving system may use the path prediction accuracy by segment when determining the risk of collision.

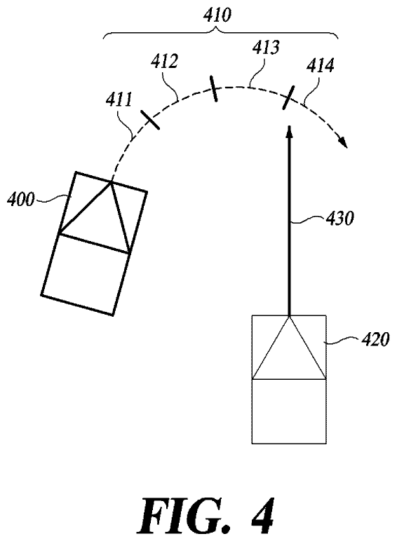

FIG. 4 shows a method for determining collision using path prediction accuracy for each segment. In FIG. 4, the dotted line 410 represents the predicted path of the subject vehicle 400, and the solid line 430 represents the predicted path of a target vehicle 420.

If the path 410 of the subject vehicle 400 is determined to be valid, conventional methods determines the risk of collision with the target vehicle 420 for the entire path 410. Since the conventional methods do not consider the path prediction accuracy by segment, the risk of collision is determined even when the predicted path 410 of the subject vehicle 400 is valid only for the initial stage. Accordingly, the autonomous driving system determines that the subject vehicle 400 collide with the target vehicle 420 in the fourth segment 414 and performs collision avoidance control.

On the other hand, the autonomous driving system according to the present disclosure determines the risk of collision only for the segments where the path prediction is deemed valid. In FIG. 4, it is assumed that the autonomous driving system determines the validity of path prediction based on a threshold of 0.7. It is assumed that the path prediction accuracy of the first segment is 0.9, the path prediction accuracy of the second segment is 0.7, the path prediction accuracy of the third segment is 0.5, and the path prediction accuracy of the fourth segment is 0.2.

Since the path prediction accuracy of the first and second segment are 0.7 or higher, the autonomous driving system determines the paths of the first segment 411 and the second segment 412 as valid paths. Therefore, the autonomous driving system determines the risk of collision using the paths of the first segment 411 and the second segment 412. Since the path prediction accuracy of the first segment 411 and the second segment 412 are less than 0.7, the autonomous driving system determines the path of the third segment 413 and the fourth segment 414 as invalid paths. The autonomous driving system does not determine the risk of collision using the path of the third segment 413 and the fourth segment 414.

The autonomous driving system according to the present disclosure determines the risk of collision only for the segments (411 and 412) where the predicted paths are valid, thereby avoiding unnecessary collision risk determinant and collision avoidance control.

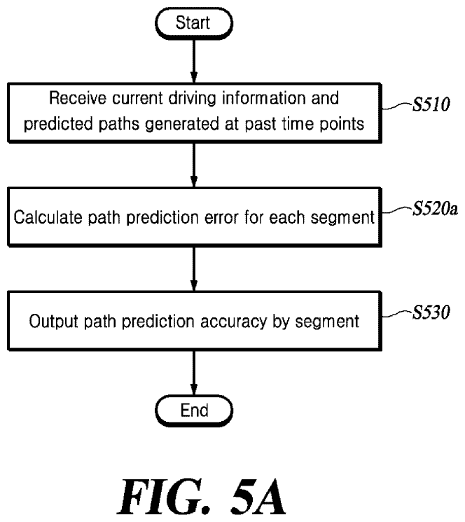

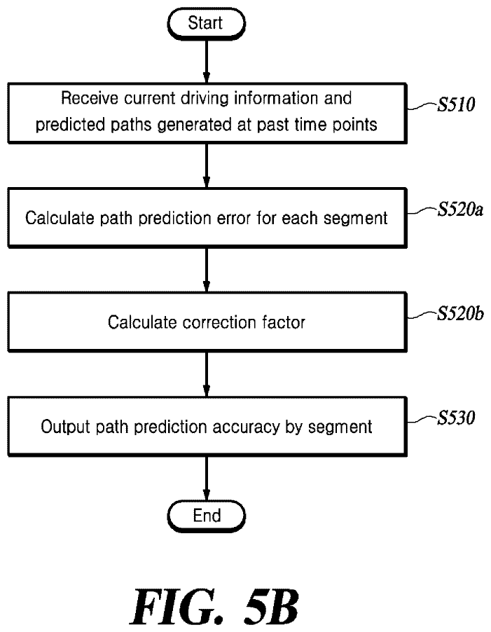

FIG. 5a is a flow diagram illustrating a process of calculating the path prediction accuracy for each segment by the path evaluation apparatus 100 according to one embodiment of the present disclosure.

The path evaluation apparatus 100 stores the current driving information of the vehicle and the predicted paths generated at past time points in the memory 110 (S510). Each of the predicted paths may include information such as position, velocity, acceleration, heading angle, and yaw rate at each time point of the subject vehicle. predicted path is generated at each time point, and the path prediction data for each segment is stored in the memory 110.

The path evaluation apparatus 100 calculates the path prediction error for each segment using the current driving information of the vehicle and the predicted driving information for each segment (S520a). The path prediction error for each segment may be calculated using Eq. 1 and/or Eq. 2. The path prediction error for each segment is calculated in real-time. The path prediction error for each segment may be calculated simultaneously or sequentially at the current time point.

The path evaluation apparatus 100 calculates and outputs the path prediction accuracy by segment using the path prediction error for each segment (S530). The path prediction accuracy by segment may be calculated using Eq. 3. The path prediction accuracy for each segment is calculated in real-time. The path prediction accuracy by segment may be calculated simultaneously or sequentially at the current time point.

FIG. 5b is a flow diagram illustrating a process of calculating the path prediction accuracy for each segment by the path evaluation apparatus 100 according to another embodiment of the present disclosure.

The path evaluation apparatus 100 stores the current driving information of the vehicle and the predicted paths generated at past time points in the memory 110 (S510). Each of the predicted paths may include information such as position, velocity, acceleration, heading angle, and yaw rate at each time point of the subject vehicle. predicted path is generated at each time point, and the path prediction data for each segment is stored in the memory 110.

The path evaluation apparatus 100 calculates the path prediction error for each segment using the current driving information of the vehicle and the predicted driving information for each segment (S520a). The path prediction error for each segment may be calculated using Eq. 1 and/or Eq. 2. The path prediction error for each segment is calculated in real-time. The path prediction error for each segment may be calculated simultaneously or sequentially at the current time point.

The path evaluation apparatus 100 calculates a correction factor for each segment using the correction factor table (S520b). The correction factor table is based on at least one of the length of a segment and the driving status information of the subject vehicle.

The path evaluation apparatus 100 calculates and outputs the path prediction accuracy by segment using the path prediction error for each segment and the correction factor for each segment (S530). The path prediction accuracy by segment may be calculated using Eq. 4. The path prediction accuracy for each segment is calculated in real-time. The path prediction accuracy by segment may be calculated simultaneously or sequentially at the current time point.

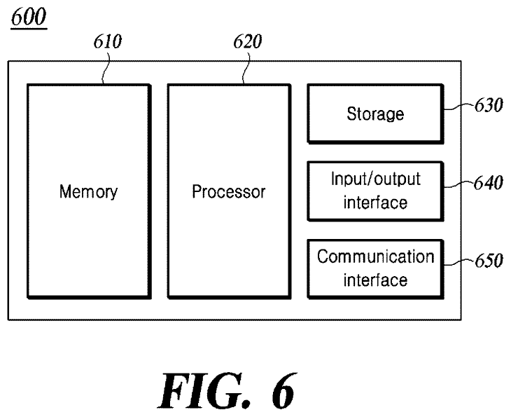

FIG. 6 is a block diagram schematically illustrating an example computing device that can be used to implement the methods or devices according to embodiments of the present disclosure.

A computing device 600 may include some or all of a memory 610, a processor 620, a storage 630, an input and output (I/O) interface 640, and a communication interface 650. The computing device 600 may structurally and/or functionally include at least a portion of the path evaluation apparatus 100. The computing device 600 may be a stationary computing device such as a desktop computer, a server, or an AI accelerator, or a mobile computing device such as a laptop computer or a smart phone.

The memory 610 may store a program that allows the processor 620 to perform methods or operations according to various embodiments of the present disclosure. For example, the program may include a plurality of instructions that are executable by the processor 620. The method illustrated in FIG. 5a and/or FIG. 5b may thus be performed by the plurality of instructions being executed by the processor 620.

The memory 610 may be a single memory or a plurality of memories. In this case, information required to perform methods or operations according to various embodiments of the present disclosure may be stored in the single memory or divided and stored in the plurality of memories. When the memory 610 is configured of the plurality of memories, the plurality of memories may be physically separated.

The memory 610 may include at least one of a volatile memory and a non-volatile memory. The volatile memory includes a static random access memory (SRAM), a dynamic random access memory (DRAM), or the like, and the non-volatile memory includes a flash memory.

The processor 620 may include at least one core capable of executing at least one instruction. The processor 620 may execute instructions stored in the memory 610. The processor 620 may be a single processor or a plurality of processors.

The storage 630 maintains stored data even when power supplied to the computing device 600 is cut off. For example, the storage 630 may include a non-volatile memory or may include a storage medium such as a magnetic tape, optical disc, or magnetic disk.

A program stored in the storage 630 may be loaded into the memory 610 before being executed by the processor 620. The storage 630 may store files created in a program language, and a program created from a file by a compiler or the like may be loaded into the memory 610. The storage 630 may store data to be processed by the processor 620 and/or data processed by the processor 620.

The I/O interface 640 may provide an interface with an input device such as a keyboard or mouse, and/or an output device such as a display device or printer. An user can trigger execution of a program in the processor 620 through the input device and/or check a processing result of the processor 620 through the output device.

The communication interface 650 may provide access to an external network. For example, the computing device 600 may communicate with another device (for example, the user terminal or the vehicle 200) via the communication interface 650.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed disclosure. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed disclosure is not to be limited by the above explicitly described embodiments but by the claims and equivalents thereof.

What is claimed is:

1. A method for determining accuracy of a predicted path for a vehicle, wherein the predicted path comprises a sequence of points representing driving information of the vehicle at each of a plurality of time points in the prediction time window, the method comprising:
receiving a first predicted path generated at a current time point and a second predicted path generated before the current time point;
determining a path prediction error of a n-th point in the first predicted path based on a difference between driving information of the vehicle at the current time point and driving information of a n-th point related to the current time point in the second predicted path, wherein the n is an integer greater than 0 and less than or equal to the number of points in the predicted path; and
determining a path prediction accuracy of n-th segment based on the path prediction error of the n-th point in the first predicted path, wherein the n-th segment is the first predicted path up to the n-th point.

2. The method of claim 1, wherein a time length from the current time point to the n-th prediction time point of the first predicted path is equal to a time length from a generation time point of the second predicted path to the current time point.

3. The method of claim 1, wherein the driving information comprises at least one of the position, heading angle, and velocity of the vehicle.

4. The method of claim 1, wherein the path prediction accuracy of the n-th segment is proportional to an inverse of the path prediction error of the n-th point in the first predicted path.

5. The method of claim 4, wherein the path prediction accuracy of the n-th segment is determined further based on a correction factor, wherein the correction factor is determined using at least one of driving stability of the vehicle and a time length of the n-th segment.

6. The method of claim 5, wherein the correction factor is proportional to an inverse of the time length of the n-th segment.

7. The method of claim 5, wherein the correction factor is proportional to the driving stability.

8. The method of claim 7, wherein the driving stability is determined based on variance of at least one of longitudinal acceleration, lateral acceleration, steering angular velocity, and yaw rate of the vehicle from a generation time point of the second predicted path to the current time point.

9. The method of claim 1, further comprising:
receiving a plurality of predicted paths generated at different time points before the current time point, including the second predicted path,
wherein the determining the path prediction error of the n-th point in the first predicted path is based on differences between the driving information of the vehicle at the current time point and the driving information of points related to the current time point in each of the plurality of predicted paths.

10. The method of claim 9, further comprising:
determining one or more valid segments based on a path prediction accuracy of the plurality of segments of the first predicted path.

11. An apparatus for determining accuracy of a predicted path for a vehicle, wherein the predicted path comprises a sequence of points representing driving information of the vehicle at each of a plurality of time points in the prediction time window, the apparatus comprising:
at least one memory storing commands; and
at least one processor,
wherein the at least one processor executes the commands to:
receive a first predicted path generated at a current time point and a second predicted path generated before the current time point;
determine a path prediction error of a n-th point in the first predicted path based on a difference between driving information of the vehicle at the current time point and driving information of a n-th point related to the current time point in the second predicted path, wherein the n is an integer greater than 0 and less than or equal to the number of points in the predicted path; and
determine path prediction accuracy for the n-th segment based on the path prediction error of the n-th point in the first predicted path, wherein the n-th segment is the first predicted path up to the n-th point.

12. The apparatus of claim 11, wherein a time length from the current time point to the n-th prediction time point of the first predicted path is equal to a time length from a generation time point of the second predicted path to the current time point.

13. The apparatus of claim 11, wherein the driving information comprises at least one of the position, heading angle, and velocity of the vehicle.

14. The apparatus of claim 11, wherein the path prediction accuracy of the n-th segment is proportional to an inverse of the path prediction error of the n-th point in the first predicted path.

15. The apparatus of claim 14, wherein the path prediction accuracy of the n-th segment is determined further based on a correction factor, wherein the correction factor is determined using at least one of a driving stability of the vehicle and a time length of the n-th segment.

16. The apparatus of claim 15, wherein the correction factor is proportional to an inverse of the time length of the n-th segment.

17. The apparatus of claim 15, wherein the correction factor is proportional to the driving stability.

18. The apparatus of claim 17, wherein the driving stability is determined based on variance of at least one of longitudinal acceleration, lateral acceleration, steering angular velocity, and yaw rate of the vehicle from a generation time point of the second predicted path to the current time point.

19. The apparatus of claim 11, wherein the processor is further to:
receive a plurality of predicted paths generated at different time points before the current time point, including the second predictive path,
wherein the determining the path prediction error of the n-th point in the first predicted path is based on differences between the driving information of the vehicle at the current time point and the driving information of points related to the current time point in each of the plurality of predicted paths.

20. The apparatus of claim 19, wherein the processor is further to:
determine one or more valid segments based on a path prediction accuracy of the plurality of segments of the first predicted path.
